(19) United States
(12) Patent Application Publication
(10) Pub. No.: US 2023/0236213 A1
(43) Pub. Date: Jul. 27, 2023

(54) AUTOMATIC SAMPLE INJECTION DEVICE

(71) Applicant: Shimadzu Corporation, Kyoto-shi (JP)

(72) Inventor: Daiki FUKUSHIMA, Kyoto-shi (JP)

(73) Assignee: Shimadzu Corporation, Kyoto-shi (JP)

(21) Appl. No.: 18/008,050

(22) PCT Filed: Dec. 15, 2020
(86) PCT No.: PCT/JP2020/046705

§ 371 Date: Dec. 2, 2022

(30) Foreign Application Priority Data
Jun. 5, 2020 (JP) 2020-098200

(51) Int. Cl. G01N 35/04; G01N 35/10

(52) U.S. Cl. CPC G01N 35/04; G01N 35/10; G01N 2035/00801

(57) ABSTRACT

An automatic sample injection device is provided with a vial placement unit (2) configured to place a vial (10) thereon, a sampler (6) provided at a position different from a position of the vial placement unit (2), the sampler being configured to collect a liquid from the vial (10), a conveyance unit (4) provided with a gripper (14) for gripping the vial (10) from above, the conveyance unit being configured to convey the vial (10) between the vial placement unit (2) and the sampler (6), a target position setting unit (22) configured to execute a teaching mode for setting a target position at which the gripper (14) is to be placed when placing the vial (10) at a predetermined position, cause a user to perform positioning of the gripper (14) to a position to be the target position in the teaching mode, and set a position of the gripper (14) positioned by the user as the target position, and a control unit (20) configured to position the gripper (14) at the target position set by the target position setting unit (22) when placing the vial (10) at the predetermined position. The target position setting unit (22) is configured to execute, in the teaching mode, an auxiliary operation for visually assisting positioning of the gripper by the user when causing the user to perform positioning of the gripper (14) to a position to be the target position.

### TECHNICAL FIELD

The present invention relates to an automatic sample injection device used in an analysis system, such as, e.g., a gas chromatography analysis system.

### BACKGROUND ART

In an analysis system for performing an analysis, such as, e.g., a gas chromatography analysis, an automatic sample injection device is often used in which a liquid, such as, e.g., a sample and a solvent, is sucked from a vial and inject it to an analysis device. Some automatic sample injection devices include a vial placement unit on which a plurality of vials for accommodating a sample or a solvent is to be placed, a sampler configured to suck a liquid in the vial and inject it to an analyzer, and a conveyance unit configured to convey the vial between the vial placement unit and the sampler by gripping the vial (see Patent Document 1). The conveyance unit grips the vial placed on the vial placement unit with the gripper and conveys it to a predetermined position. The sampler takes the vial placed at the predetermined position and performs sampling of the liquid. Further, the sampler returns the used vial to a predetermined position. When the used vial is placed at the predetermined position, the conveyance unit returns the vial placed at the predetermined position to the vial placement unit.

In such an automatic sample injection device, teaching for making the device store a position (target position) of a gripper when a vial is conveyed at a predetermined position is performed at the time of installing the device or the like. Such teaching is generally performed such that the user performs positioning of a gripper to a position directly above the vial placed at a predetermined position while visually confirming in a state in which the vial is positioned at the predetermined position. The position positioned by the user is set as a target position of the gripper at the time of the vial conveyance.

### PRIOR ART DOCUMENT

### Patent Document

Patent Document 1: Japanese Unexamined Patent Application Publication No. H3(2021)-245059

### SUMMARY OF THE INVENTION

### Problems to be Solved by the Invention

When a user performs positioning of a gripper at the time of teaching, it is difficult to confirm the positional relation between the vial placed at a predetermined position and the gripper, which makes it difficult to accurately perform the positioning of the gripper.

The present invention has been made in view of the above-described problems, and aims to facilitate positioning of a gripper by a user at the time of teaching.

### Means for Solving the Problems

An automatic sample injection device according to the present invention includes:

a vial placement unit configured to place a vial thereon;

a sampler provided at a position different from a position of the vial placement unit, the sampler being configured to collect a liquid from the vial;

a conveyance unit provided with a gripper for gripping the vial from above, the conveyance unit being configured to convey the vial between the vial placement unit and the sampler;

a target position setting unit configured to execute a teaching mode for setting a target position at which the gripper is to be placed when placing the vial at a predetermined position, cause a user to perform positioning of the gripper to a position to be the target position in the teaching mode, and set a position of the gripper positioned by the user as the target position, and

a control unit configured to position the gripper at the target position set by the target position setting unit when placing the vial at the predetermined position,

wherein the target position setting unit is configured to execute, in the teaching mode, an auxiliary operation for visually assisting positioning of the gripper by the user when causing the user to perform positioning of the gripper to a position to be the target position.

### Effects of the Invention

In the automatic sample injection device according to the present invention, an auxiliary operation for visually assisting positioning of the gripper by the user when setting a target position of the gripper at the time of teaching is executed. Therefore, the positioning of the gripper by the user at the time of the teaching can be facilitated.

### BRIEF DESCRIPTION OF THE DRAWINGS

FIG. 1 is a schematic configuration diagram showing one example of an automatic sample injection device.

FIG. 2 is a conceptual diagram showing a gripper according to the example.

FIG. 3 is a flowchart showing an operation at the time of teaching according to the example.

FIG. 4 is a diagram showing one example of an auxiliary operation for positioning at the time of teaching.

FIG. 5 is a diagram showing another example of an auxiliary operation for positioning at the time of teaching.

FIG. 6 is a diagram showing an example in which a protrusion for assisting positioning at the time of teaching is formed on the gripper.

### EMBODIMENTS FOR CARRYING OUT THE INVENTION

Hereinafter, with reference to the attached drawings, one example of an automatic sample injection device according to the present invention will be described.

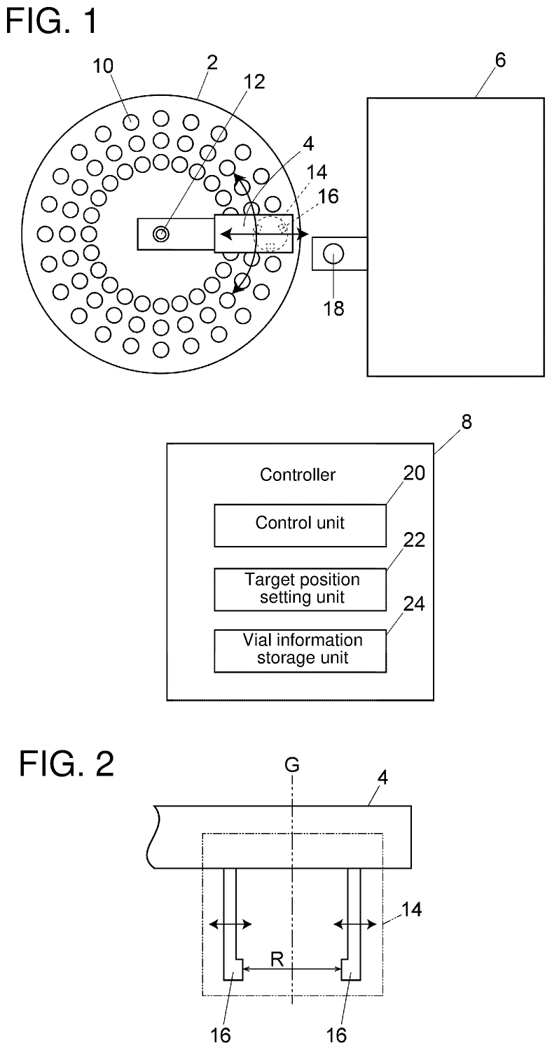

As shown in FIG. 1, an automatic sample injection device is provided with a vial placement unit 2, a conveyance arm 4 (conveyance unit), a sampler 6, and a controller 8.

The vial placement unit 2 is a disk-shaped table configured to place a plurality of vials 10 thereon side by side on a circumference. The conveyance arm 4 is for conveying a vial 10 between the vial placement unit 2 and the sampler 6. The conveyance arm 4 is integrally provided to the vial placement unit 2 and rotates within a horizontal plane about a shaft 12 provided at the central part of the vial placement unit 2.

A gripper 14 for gripping the vial 10 placed on the vial placement unit 2 from above is provided at a distal end portion of the conveyance arm 4. The gripper 14 of the conveyance arm 4 is provided with a plurality of claws 16 arranged on the same circumference. As shown in FIG. 2, the gripper 14 is configured to change the diameter R (opening degree) of a circumference along which the claws 16 are arranged by symmetrically moving the claws 16 with respect to the center in a plane to thereby grip or release the outer peripheral surface of the vial 10.

Returning to FIG. 1, the conveyance arm 4 is configured to be stretchable. The gripper 14 is configured to move vertically in accordance with the vertical movements of the conveyance arm 4 or move vertically by itself. With this configuration, the conveyance arm 4 can grip and convey an arbitrary vial 10 placed on the vial placement unit 2 by the rotational and telescoping movements in a horizontal plane, and the vertical movements of the gripper 14.

The sampler 6 is arranged on a side of the vial placement unit 2 and is provided with a vial receiving portion 18 for receiving the vial 10 from the conveyance arm 4. The conveyance arm 4 can convey an arbitrary vial 10 placed on the vial placement unit 2 to the vial receiving portion 18 and place it on the vial receiving portion 18 and also can grip the vial 10 placed on the vial receiving portion 18 and place it on the vial placement unit 2. The sampler 6 performs operations, such as,. e.g., collecting a liquid, such as, e.g., a sample, from the vial 10 placed on the vial receiving portion 18 and injecting the liquid into an analysis device, such as, e.g., a gas chromatograph, by the conveyance arm 4.

The controller 8 is configured to perform at least an operation management of the conveyance arm 4 and is realized by an electronic circuit including a CPU (Central Processing Unit), an information storage device, and the like. The controller 8 is provided with a control unit 20, a target position setting unit 22, and a vial information storage unit 24. The control unit 20 and the target position setting unit 22 are functions realized by a CPU executing programs, and the vial information storage unit 24 is a function realized by a partial storage area of the information storage device.

The control unit 20 is configured to control the operation of the conveyance arm 4 using the information stored in a storage device (not shown) of the controller 8.

The target position setting unit 22 is a function for setting a position (target position) at which the gripper 14 is to be positioned when the conveyance arm 4 grips the vial 10 at the vial receiving portion 18 or when the conveyance arm 4 places the vial 10 at the vial receiving portion 18. The setting of the target position is performed by executing a teaching mode and causing the user to perform positioning of the gripper 14 to a position to be a target position.

The target position setting unit 22 is configured to execute an auxiliary operation for visually assisting the positioning of the gripper 14 by the user in a teaching mode. In this example, as shown in FIG. 4, the opening degree R of the gripper 14 is set to be slightly larger (R=W+α) than the maximum outer diameter W of the cap of the vial 10 during the teaching mode.

The vial information storage unit 24 stores the information about the type of a vial to be placed on the vial placement unit 2, which is previously set by the user. The target position setting unit 22 determines the maximum outer diameter W of the cap of the vial 10 assumed for the type of the vial based on the type of the vial stored in the vial information storage unit 24, when adjusting the opening degree of the gripper 14 as an auxiliary operation, and adjusts the opening degree R of the gripper 14 based on the determined maximum outer diameter W. Although not shown, the controller 8 stores information on the correlation between the type of the vial 10 and the maximum outer diameter of the cap.

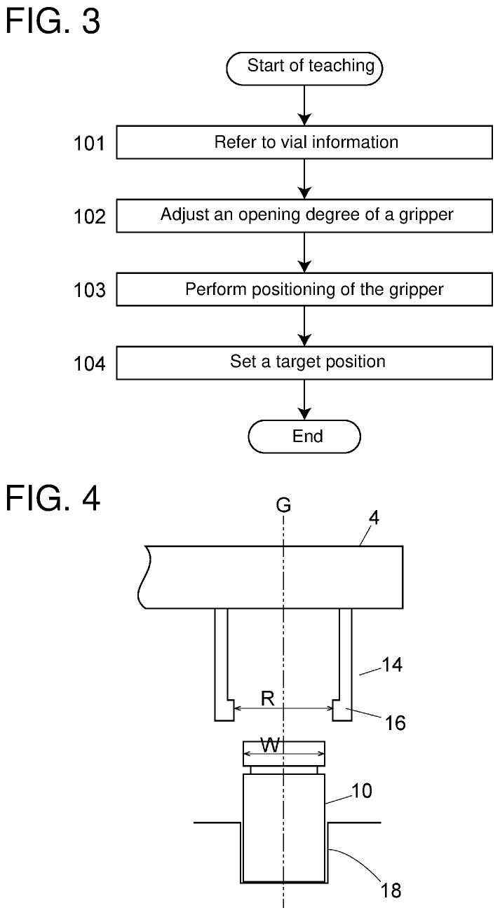

The operation at the time of the teaching will be described with reference to a flowchart of FIG. 3.

When the user inputs an instruction to start teaching to the controller 8, the target position setting unit 22 executes a teaching mode. The teaching is performed in a state in which the vial 10 is placed at the vial receiving portion 18. When executing the teaching mode, the target position setting unit 22 refers to the vial information stored in the vial information storage unit 24 (Step 101) to determine the maximum outer diameter of the cap of the vial 10 and adjust the opening degree of the gripper 14 (Step 102).

The user manually adjusts the position (the rotational angle θ and the amount of elongation of the conveyance arm 4) of the gripper 14 to align the center axis G of the gripper 14 with the center of the cap of the vial 10 (see FIG. 4) to position the gripper 14 (Step 103). When the user inputs the determination of the target position to the controller 8, the target position setting unit 22 sets the position of the gripper 14 positioned by the user as a target position (Step 104).

The target position of the gripper 14 set by the target position setting unit 22 is used when the control unit 20 controls the operation of the conveyance unit 4. The control unit 20 is configured to position the gripper 14 at the target position set by the target position setting unit 22 when placing the vial 10 at the vial receiving portion 18 and when gripping the vial 10 placed at the vial receiving portion 18.

In a conventional automatic sample injection device, it is common to maximize the opening degree of the gripper 14 during a teaching mode. However, in a case where the gripper 14 is maximized in the opening degree, when the user positions the gripper 14 to a target position, it is difficult to grasp the positional relation between the vial 10 and the gripper 14. On the other hand, in this example, the opening degree of the gripper 14 is adjusted to be be slightly larger than the outer diameter of the vial 10, and therefore, it becomes easy for the user to grasp the positional relation between the gripper 14 and the vial 10, which facilitates the positioning of the gripper 14.

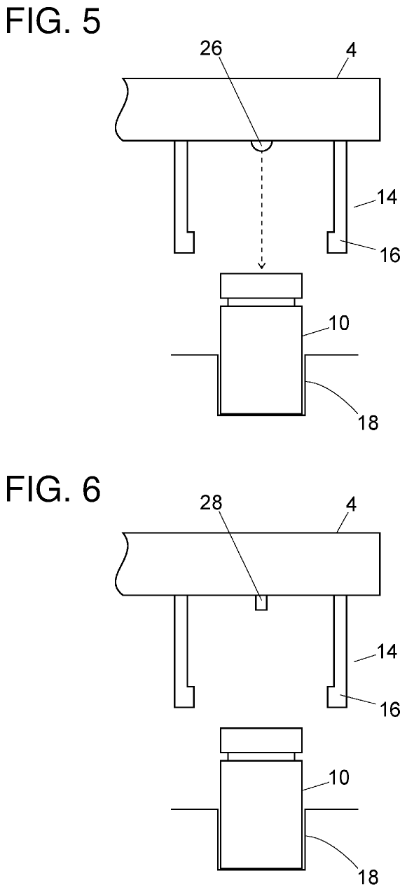

Note that the auxiliary operation for assisting the positioning of the gripper 14 during the teaching mode is not limited to the adjustment of the opening degree of the gripper 14. As shown in FIG. 5, a light source 26 oriented vertically downward may be provided at the center of the gripper 14, and the light source 26 may be turned on during a teaching mode as an auxiliary operation. When the light source 26 provided at the center of the gripper 14 is turned on, the upper surface of the cap of the vial 10 is illuminated by the light from the light source 26. Therefore, the center position of the gripper 14 can be easily visually grasped, which makes it easy to align the center axis of the gripper 14 with the center axis of the vial 10. The illumination of the light source 26 can be performed by combining with the auxiliary operation of adjusting the opening degree of the gripper 14 to a degree corresponding to the outer diameter of the cap of the vial 10.

Further, in order to make the center position of the gripper 14 visible, a visible protrusion 28 may be provided at the center position of the gripper 14. By combining with the auxiliary operation of adjusting the opening degree of the gripper 14 to a degree corresponding to the outer diameter of the vial 10, the positioning of the gripper 14 can be further facilitated.

It should be noted that the examples described above are merely exemplary embodiments of the automatic sample injection device according to the present invention. Embodiments of the automatic sample injection device according to the present invention are as follows.

In one embodiment of the an automatic sample injection device according to the present invention, the automatic sample injection device includes:

a vial placement unit configured to place a vial thereon;

a sampler provided at a position different from a position of the vial placement unit, the sampler being configured to collect a liquid from the vial;

a conveyance unit provided with a gripper for gripping the vial from above, the conveyance unit being configured to convey the vial between the vial placement unit and the sampler;

a target position setting unit configured to execute a teaching mode for setting a target position at which the gripper is to be placed when placing the vial at a predetermined position, cause a user to perform positioning of the gripper to a position to be the target position in the teaching mode, and set a position of the gripper positioned by the user as the target position, and

a control unit configured to position the gripper at the target position set by the target position setting unit when placing the vial at the predetermined position,

wherein the target position setting unit is configured to execute, in the teaching mode, an auxiliary operation for visually assisting positioning of the gripper by the user when causing the user to perform positioning of the gripper to a position to be the target position.

In one aspect of the above-described embodiment, the automatic sample injection device further includes:

a vial information storage unit configured to store information on the vial,

wherein the gripper is configured to grip an outer peripheral surface of the vial by adjusting an opening degree of the gripper, and

wherein the target position setting unit is configured to set the gripper to have an opening degree corresponding to an outer diameter of the vial by using the information stored in the vial information storage unit, as an auxiliary operation when causing the user to perform positioning of the gripper.

With this configuration, it becomes easily for the user to grasp the positional relation between the gripper and the vial, which facilitates the positioning of the gripper.

In the first aspect of the present invention, it may be configured such that the target position setting unit is configured to determine the opening degree of the gripper when causing the user to perform positioning of the gripper, based on an outer diameter of the cap mounted on a top portion of the vial.

In a second aspect of the above-described embodiment, the gripper is configured such that a plurality of claws for gripping the outer peripheral surface of the vial is arranged on a same circumference and that the opening degree of the gripper is adjusted by changing a diameter of a circumference along which the plurality of claws is arranged, a light source configured to emit light vertically downward is provided at a center of the circumference along which the plurality of claws of the gripper is arranged, and the target position setting unit is configured to turn on the light source of the gripper as the auxiliary operation.

With such an aspect aspect, it becomes possible to visually recognize the center position of the grippe since the light from the light source is illuminated on the upper surface of the cap of the vial, thereby facilitating the alignment of the center axis of the gripper and the center axis of the vial. This second aspect of the present invention may be combined with the first aspect of the present invention.

In the third aspect of the above-described embodiment, the gripper is configured such that a plurality of claws for gripping an outer peripheral surface of the vial is arranged on a same circumference and that the opening degree of the gripper is adjusted by changing a diameter of a circumference along which the plurality of claws is arranged, and the gripper is provided with a marker at a center of a circumference along which the plurality of claws is arranged, the marker being visually recognizable.

With this configuration, the center position of the gripper becomes visible, thereby facilitating the positioning of the gripper at the time of teaching. This third aspect of the present invention may be combined with the first aspect of the present invention described above.

In the fourth aspect of the above-described embodiment, the vial placement unit and the sampler are provided as separate members, and the conveyance unit is integrally provided to the vial placement unit.

This fourth aspect of the present invention can be combined with the first to third aspects of the present invention described above.

In the fourth aspect of the present invention, the predetermined position is a position of a vial receiving unit provided to the sampler to convey the vial between the sampler and the conveyance unit.

### DESCRIPTION OF SYMBOLS

2: Vial placement unit
4: Conveyance arm
6: Sampler
8: Controller
10: Vial
12: Shaft
14: Gripper
16: Craw
18: Container receiving portion
20: Control unit
22: Target position setting unit
24: Vial information storage unit

1. An automatic sample injection device comprising:
a vial placement unit configured to place a vial thereon;
a sampler provided at a position different from a position of the vial placement unit, the sampler being configured to collect a liquid from the vial;
a conveyance unit provided with a gripper for gripping the vial from above, the conveyance unit being configured to convey the vial between the vial placement unit and the sampler;
a target position setting unit configured to execute a teaching mode for setting a target position at which the gripper is to be placed when placing the vial at a predetermined position, cause a user to perform positioning of the gripper to a position to be the target position in the teaching mode, and set a position of the gripper positioned by the user as the target position, and
a control unit configured to position the gripper at the target position set by the target position setting unit when placing the vial at the predetermined position,
wherein the target position setting unit is configured to execute, in the teaching mode, an auxiliary operation for visually assisting positioning of the gripper by the user when causing the user to perform positioning of the gripper to a position to be the target position.

2. The automatic sample injection device as recited in claim 1, further comprising:
a vial information storage unit configured to store information on the vial,
wherein the gripper is configured to grip an outer peripheral surface of the vial by adjusting an opening degree of the gripper, and
wherein the target position setting unit is configured to set the gripper to have an opening degree corresponding to an outer diameter of the vial by using the information stored in the vial information storage unit, as an auxiliary operation when causing the user to perform positioning of the gripper.

3. The automatic sample injection device as recited in claim 2,
wherein the target position setting unit is configured to determine the opening degree of the gripper when causing the user to perform positioning of the gripper, based on an outer diameter of the cap mounted on a top portion of the vial.

4. The automatic sample injection device as recited in claim 1,
wherein the gripper is configured such that a plurality of claws for gripping the outer peripheral surface of the vial is arranged on a same circumference and that the opening degree of the gripper is adjusted by changing a diameter of a circumference along which the plurality of claws is arranged,
wherein a light source configured to emit light vertically downward is provided at a center of the circumference along which the plurality of claws of the gripper is arranged, and
wherein the target position setting unit is configured to turn on the light source of the gripper as the auxiliary operation.

5. The automatic sample injection device as recited in claim 1,
wherein the gripper is configured such that a plurality of claws for gripping an outer peripheral surface of the vial is arranged on a same circumference and that the opening degree of the gripper is adjusted by changing a diameter of a circumference along which the plurality of claws is arranged, and
wherein the gripper is provided with a marker at a center of a circumference along which the plurality of claws is arranged, the marker being visually recognizable.

6. The automatic sample injection device as recited in claim 1,
wherein the vial placement unit and the sampler are provided as separate members, and
wherein the conveyance unit is integrally provided to the vial placement unit.

7. The automatic sample injection device as recited in claim 6,
wherein the predetermined position is a position of a vial receiving unit provided to the sampler to convey the vial between the sampler and the conveyance unit.

8. The automatic sample injection device as recited in claim 1,
wherein the auxiliary operation is an operation of visually assisting the positioning of the gripper by the user to align a center of the gripper with a center of a cap mounted on a top portion of the vial.
